(19) United States
(12) Patent Application Publication
(10) Pub. No.: US 2008/0292327 A1
(43) Pub. Date: Nov. 27, 2008

(54) IMAGE FORMING DEVICE

(75) Inventors: Kyoichiro HAYASHI, Kanagawa (JP); Keiko Morita, Nara (JP); Yasuhiro Iwashima, Hyogo (JP)

Correspondence Address: GLOBAL IP COUNSELORS, LLP, 1233 20TH STREET, NW, SUITE 700, WASHINGTON, DC, 20036-2680, US

(73) Assignee: KYOCERA MITA CORPORATION, Osaka (JP)

(21) Appl. No.: 12/110,896

(22) Filed: Apr. 28, 2008

(30) Foreign Application Priority Data
May 25, 2007 (JP) 2007-139339
May 31, 2007 (JP) 2007-145663

(51) Int. Cl. G03G 15/00

(52) U.S. Cl. 399/16

(57) ABSTRACT

An image forming device of the present invention includes searching section that is configured to search whether a sheet of paper having a suitable size for an essential print object in order to print out the essential print object. In addition, the image forming device includes selecting section and printing section. The selecting section is configured to perform a selection of a sheet of secondary suitable-sized paper, the size of which is larger than the sheet of paper having the suitable size for the essential print object, when the sheet of paper having the suitable size for the essential print object does not exist. The printing section is configured to print the essential print object on the sheet of secondary suitable-sized paper. Accordingly, the essential print object is to be absolutely printed on some form of paper.

### CROSS-REFERENCE TO RELATED APPLICATIONS

This application claims priority to Japanese Patent Application Nos. 2007-139339 and 2007-145663, the entirety of which is hereby incorporated by reference.

### BACKGROUND OF THE INVENTION

1. Field of the Invention

The present invention relates to an image forming device such as a printer, a photocopier, a facsimile machine, and a multifunction peripheral.

2. Background Information

Recently, image forming devices, such as a printer, a photocopier, a facsimile machine, and a multifunction peripheral (MFP) having all the functions of these devices, have been widely used. Especially, the image forming device is used as an indispensable office machine in the office environment and the like. Some of the image forming devices include a plurality of paper feeding cassettes for storing a single or plurality of sheets of paper, and the sizes of the sheets of paper stored in the paper feeding cassettes are different from each other (e.g., the sizes A4, B4, and A3). In addition, some of the image forming devices are configured to be capable of performing printing while a sheet of paper having the optimal size is selected depending on the print object's size.

For example, when the image data are received through the fax transmission, the vertical and horizontal lengths of the image are calculated, which are necessary to print out the image data. When the calculated size of the image is within the size A4, a sheet of paper having the size A4 is selected and the image data are printed thereon. Also, when a user photocopies, he/she is allowed to print (i.e., photocopy) a manuscript while he/she decides the size of the manuscript for himself/herself and manually selects the optimal paper size.

By the way, when a user performs the above described printing, he/she sometimes encounters a situation in which he/she cannot perform printing with a sheet of paper having the optimal size (i.e., paper empty condition) because the sheets of paper stored in a specific paper feeding cassette have completely run out. In this situation, the paper empty condition is generally displayed on a display unit such as a touch screen of the image forming device, and thus a user is instructed to supply a sheet of paper having the optimal size to the corresponding paper feeding cassette.

However, when printing is urgently needed, for instance, the following method may be employed. That is, a sheet of paper having the size that most closely approximates the sheet of paper having the optimal size is selected, and printing is performed on the selected sheet of paper. Japanese Patent Application Publication No. H-06-247000 discloses an image forming device to which the above method is adopted.

By the way, the image forming device stores a variety of records such as a facsimile receiving record illustrated in FIG. 4A and an inspection and maintenance record illustrated in FIG. 4B.

The facsimile receiving record includes a variety of items such as “date and time” when a facsimile transmission is received, “fax number of source/sender,” and “image ID.” For example, the facsimile receiving record is used prove that a specific document (e.g., contract document) has been received. On the other hand, the inspection and maintenance record includes a variety of items such as “day and time” when toner is supplied. The inspection and maintenance record is used for referring to maintenance service when there is something wrong with the printing operation.

It is necessary absolutely to print out the records such as the facsimile receiving record and the inspection and maintenance record in order to use the records for the above described purposes. In general, the records are printed out in response to a user's instruction, or are automatically printed out on a regular basis.

Actually, it is not surprising that a user encounters a situation in which a sheet of paper having the optimal size has completely run out when he/she prints out the records. However, the art disclosed in Japanese Patent Application Publication No. JP-H06-247000 does not cope address this situation. Therefore, in the conventional method, printing of the records is kept in a standby state until a user supplies a sheet of paper having the optimal size to the image forming device.

However, as illustrated above, when a user needs to prove urgently whether or not a contract document has been received, for instance, he/she cannot wait for the paper supply. Also, as described above, when the records are configured to be automatically printed out on a regular basis, it is convenient for the office management to print out the records in some form even if a sheet of paper having the optimal size has run out. If this is done, it is possible to access the printed records even when the image forming device is not available in some situations (e.g., blackout) and the records are needed. It is also possible to avoid such a situation in which the data, which have not been printed out, are lost because of the failure of the image forming device.

Also, when a user photocopies, for instance, he/she is allowed to print (i.e., photocopy) a manuscript while he/she decides the size of the manuscript and manually selects a sheet of paper having the optimal size. Furthermore, when the image forming device is provided with a detecting device detects the manuscript size (e.g., CCD; charge coupled device), a user is also allowed to perform printing while he/she manually selects a sheet of paper having the optimal size based on the detected manuscript size.

By the way, the sizes A4, B4, A3 and the like are often used in a printing operation, and are classified as “the standard size.” However, the manuscript size is sometimes classified as the non-standard size because it does not correspond to the standard size.

When a user prints out the manuscript having the non-standard size, he/she inputs the vertical and horizontal lengths of the manuscript having the non-standard size in unit of millimeter (mm) through a touch screen and the like. Then, the user supplies a sheet of paper having the non-standard size to the image forming device through a manual paper feeding tray provided therein, and prints out the manuscript.

However, the operation of inputting the lengths in unit of mm is complicated and cumbersome for a user, and sometimes an error (e.g., input error) occurs. In response to this, Japanese Patent Application Publication No. JP-A-2000-108460 discloses an art for supporting the input operation. Specifically, a plurality of options for the non-standard size are preliminarily registered in the image forming device, and the options are configured to be displayed as icons on the touch-screen when a user inputs the non-standard size. Accordingly, a user's error input is prevented.

However, the art disclosed in Japanese Patent Application Publication No. JP-A-2000-108460 has the following problems.

Recently, in some office environments and the like, only a specific person (i.e., administrator) is allowed to change the configuration of the image forming device for the purpose of ensuring the safety of information management.

In addition, an input of the non-standard size is often classified as an access-limited configuration change. Therefore, a general user excluding the administrator is not allowed to input the non-standard size unless the administrator permits him/her to do this and he/she obtains the control authority of the image forming device. Therefore, printing of a manuscript having a non-standard size is quite complicated and cumbersome for a general user.

In view of the above, it will be apparent to those skilled in the art from this disclosure that there exists a need for an improved image forming device. This invention addresses this need in the art as well as other needs, which will become apparent to those skilled in the art from this disclosure.

### SUMMARY OF THE INVENTION

The present invention is produced in view of the above described problems, and an object thereof is to provide an image forming device that enhances convenience in office management and safety in information management by reliably and clearly printing a record (e.g., facsimile receiving record) even when a paper size has run out.

In addition, the present invention is produced in view of the above described problems, and an object thereof is to provide an image forming device that allows a general user without the control authority to obtain simply and rapidly a printed material having the non-standard size.

For the purpose of achieving the above described object, the following configuration is applied to the present invention. First, the present invention is premised on an image forming device that includes a plurality of paper feeding cassettes. Here, the paper feeding cassettes are configured to store respectively a single or plurality of sheets of paper, and the sheets of paper have a plurality of paper sizes.

In this type of image forming device, when a print object that is absolutely required to be printed (hereinafter referred to as “essential print object”) is printed out, a searching section is provided, which is configured to search whether a sheet of paper having a suitable size for the essential print object. Here, the term “essential print object” means a print object regarding the image forming device (e.g., the above described facsimile receiving record and the inspection and maintenance record), printing of which is regarded as necessary by a user.

Also, a selecting section and a printing section are provided. Here, the selecting section is configured to perform a selection of a sheet of paper having a size larger than the sheet of paper having the suitable size for the essential target (which is hereinafter referred to as “secondary suitable-sized paper”) when the sheet of paper having the suitable size for the essential target does not exist. The printing section is configured to print the essential print object on a sheet of secondary suitable-sized paper. Accordingly, it is possible to print the essential print object on some form of paper. Note that it is possible to perform the selection based on a user's instruction. Also, a managing section may be provided, which is configured to manage frequency of the section for each of the plurality of paper sizes. Here, it is possible for the selecting section to select automatically the sheet of secondary suitable-sized paper based on the frequency. Accordingly, it is possible for the image forming device to learn a sheet of secondary suitable-sized paper preferred by a user and to use preferentially the sheet of secondary suitable-sized paper. Therefore, it is possible to standardize the paper size, and an operation such as failing of a sheet of paper on which the essential print object is printed becomes convenient.

Furthermore, an authenticating section may be provided, which is configured to perform a user authentication. Here, it is also possible for the managing section to manage the frequency for each of users. According to the configuration, a sheet of secondary suitable-sized paper is selected, which corresponds to each user's preference. Therefore, the above described operation (e.g., filing) becomes more convenient.

Also, it is possible for the printing section to expand the essential print object to the suitable size for the sheet of secondary suitable-sized paper and print the expanded essential print object on the sheet of secondary suitable-sized paper. Accordingly, it is possible to produce a sheet of paper on which the essential print object is printed in a form viewable for a user depending on the user's needs.

As described above, according to the image forming device of the present invention, it is possible to enhance convenience of the office management and safety of the information management with a configuration that a record (e.g., facsimile receiving record) is reliably and clearly printed out even when a sheet of paper has run out.

Also, for the purpose of achieving the above object, the following configuration is applied to the present invention.

First, the present invention is premised on an image forming device that includes a plurality of paper feeding cassettes, a detecting section, and a searching section. The paper feeding cassettes are configured to store a single or plurality of sheets of paper, and the sheets of paper have a plurality of paper sizes. The detecting section is configured to detect the size of a manuscript. The searching section is configured to search whether a sheet of paper having suitable size for the manuscript exists or not.

In the image forming device, a judging section and a specifying section are provided. The judging section is configured to judge whether the size of the manuscript is classified as either a standard size or a non-standard size. The specifying section is configured to specify a sheet of paper having the standard size larger than the size of the manuscript when the size of the manuscript is judged to be classified as the non-standard size.

Next, a manuscript printings section is provided, which is configured to print the manuscript on the specified sheet of paper having the standard size. Accordingly, the manuscript is printed on a sheet of paper having the standard size that most closely approximates to the non-standard size.

Next, a frame line printing section is provided, which is configured to print a frame line having the non-standard size on the back side of the sheet of paper having the standard size so that the position of the frame boarder line corresponds to the position of the manuscript on the front side of the sheet of paper having the standard size. Accordingly, a user is capable of cutting the printed sheet of paper along the frame boarder line as needed, and is thus capable of obtaining a printed material having the non-standard size.

Note that the specifying section may be configured to specify a sheet of paper having the smallest standard size that is larger than the manuscript having the non-standard size. Accordingly, it is possible to contribute to the resource saving.

As described above, a user is capable of simply and rapidly obtaining a printed material having the non-standard size without the control authority of the image forming device.

These and other objects, features, aspects, and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a schematic cross-sectional view of the entire configuration of a multifunction peripheral (MFP) according to a first preferred embodiment of the present invention;

FIG. 2 is a schematic view illustrating control-related elements of the MFP of the first embodiment of the present invention;

FIG. 3 is a view of a diagram illustrating a configuration of software of the MFP of the first embodiment of the present invention;

FIG. 4A is a view of a diagram illustrating an example of an essential print object;

FIG. 4B is a view of a diagram illustrating an example of the essential print object;

FIG. 5 is a view of a diagram illustrating a configuration of software of a MFP according to a second preferred embodiment of the present invention;

FIG. 6 is a view of an example of a correspondence table in which a specifying unit is provided; and

FIG. 7 is a view of a diagram for explaining printing of a frame line.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

### First Embodiment

A first preferred embodiment of the present invention will be hereinafter explained with reference to the attached figures for the purpose of understanding of the present invention. In the embodiment, the present invention is realized as a digital multifunction peripheral (MFP) that is a form of the image forming device.

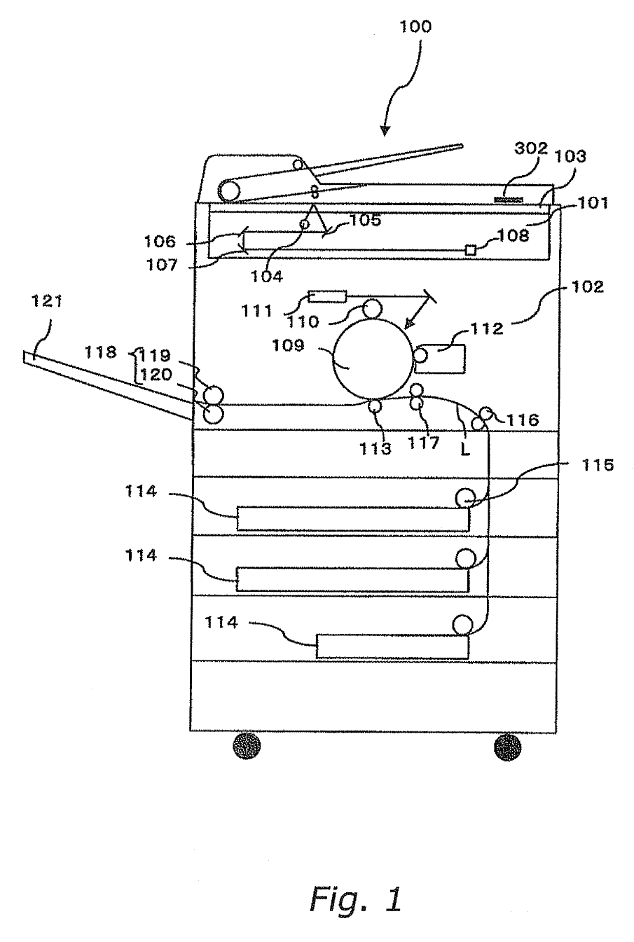

FIG. 1 is a schematic view of the entire configuration of a MFP 100 of the first embodiment. When a user performs printing of a manuscript with the MFP 100, he/she puts the manuscript on a manuscript platen 103, and an instruction of printing the manuscript is performed through operating buttons on a touch screen 302 that is provided in the vicinity of the manuscript platen 103. When the instruction is received, printing is performed by the operation of the sections (i.e., driving sections).

In an image scanning section 101, light irradiated by a light source 104 is reflected by the manuscript disposed on the manuscript platen 103, and is guided to an image pickup device 108 (e.g., CCD; charge coupled device) via mirrors 105, 106, and 107. The image pickup device 108 is configured to convert the received light into electricity, and generates the image data of the manuscript. Thus, the image data of the manuscript are scanned in the image scanning section 101.

A photosensitive drum 109 provided in an image forming section 102 is configured to rotate at a constant speed in a predetermined direction. An exposing device 111, an electric charging device 110, a developing device 112, a transferring device 113, and the like are disposed to surround the photosensitive drum 109 sequentially from the upstream side in the rotational direction of the photosensitive drum 109. The electric charging device 110 is configured to charge electrically and uniformly the surface of the photosensitive drum 109. The exposing device 111 is configured to irradiate light in accordance with the image data scanned in the image scanning section 101, and is configured to form an electrostatic latent image on the photosensitive drum 109. The developing device 112 is configured to attach toner onto the electrostatic latent image formed by the exposing device 111, and is thus configured to form a toner image on the photosensitive drum 109. The transferring device 113 is configured to transfer the toner image formed on the photosensitive drum 109 to a sheet of paper. As described above, the series of processing operations are performed in the image forming section 102 while the photosensitive drum 109 rotates.

In addition, when printing is performed, in the image forming section 102, a single sheet of paper is pulled from any of a plurality of paper feeding cassettes 114 to a transporting path L with a pickup roller 115. The paper feeding cassettes 114 are configured to store a single or plurality of sheets of paper, respectively, and the sizes of the sheets of paper stored therein are different from each other among the paper feeding cassettes 114. A sheet of paper, the size of which corresponds to the size selected by a user depending on his/her intended use, is fed to the transporting path L. The sheet of paper pulled to the transporting path L is transported to a position between the photosensitive drum 109 and the transferring device 113 by a transporting roller 116 and a resist roller 117.

When the sheet of paper passes through a position between a heating roller 119 and a pressing roller 120 in a fixing device 118, a visible image is fixed onto the sheet of paper by way of the heat and the pressing force applied to the sheet of paper. For the purpose of appropriately performing fixation, the amount of heat from the heating roller 119 is optimally set to a predetermined amount in accordance with the paper size. The image forming section 102 is configured to discharge the sheet of paper passing through the fixing device 118 to a discharging tray 121.

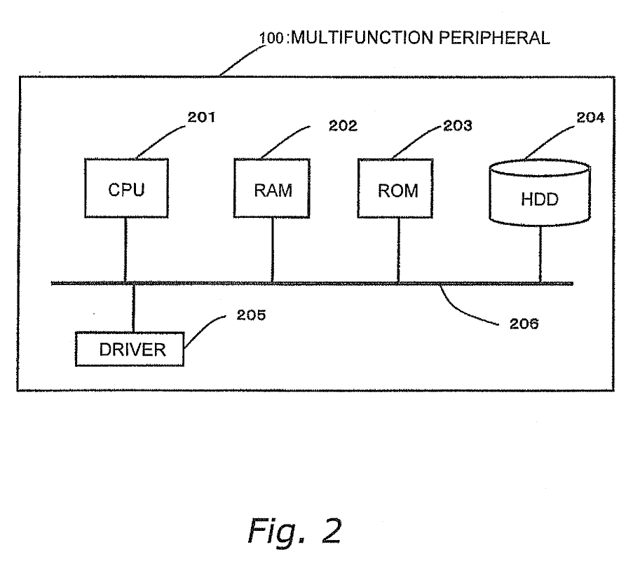

FIG. 2 is a view of a schematic diagram illustrating control-related elements included in the MFP 100 of the present invention.

In the MFP 100, a CPU (central processing unit) 201, a RAM (random access memory) 202, a ROM (read-only memory) 203, an HDD (hard disk drive) 204, and a driver 205 corresponding to the above described driving sections in printing, are connected to each other through an internal bus 206.

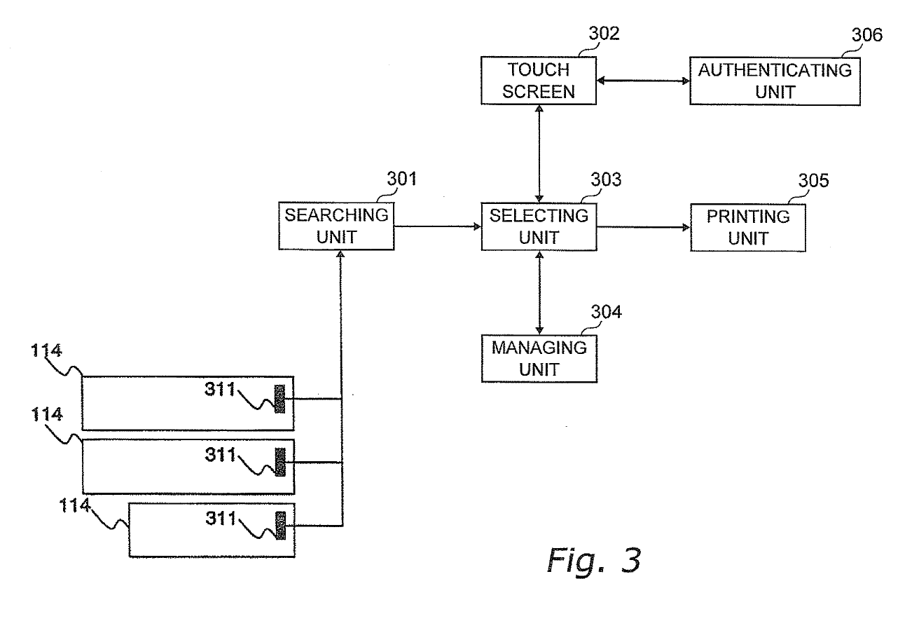

The CPU 201 is configured to use the RAM 202 as a working area, and is configured to execute a program stored in the ROM 203, the HDD 204, or the like. The CPU 201 is configured to control operations of the driving sections illustrated in FIG. 1 by sending/receiving the data and the instruction to/from the driver 205 based on the result of the execution. In addition, each of plurality of sections to be described (illustrated in FIG. 3) excluding the above described driving sections also is configured to perform an operation when the CPU 201 executes a program.

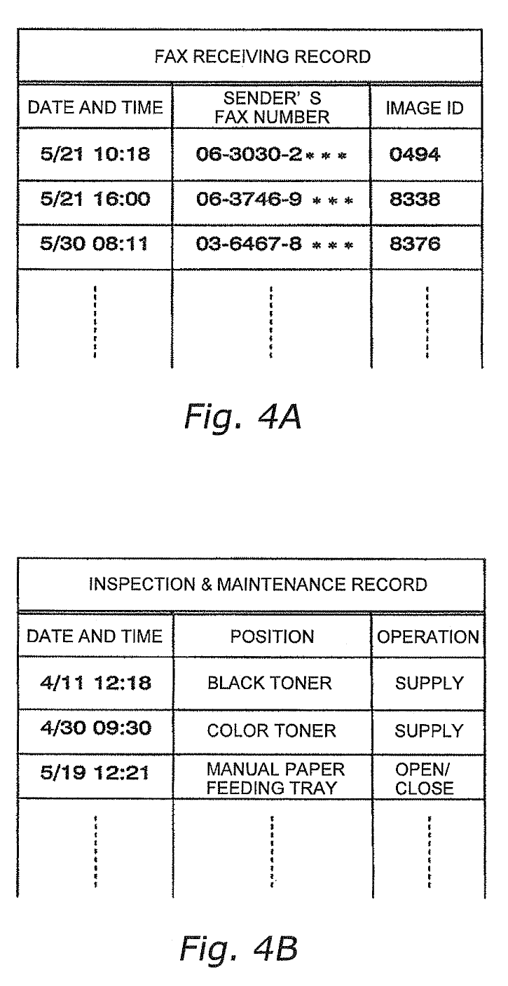

FIG. 3 is a diagram illustrating a configuration of software of the MFP 100 of the present embodiment. Data of a print object that is absolutely required to be printed out (hereinafter referred to as “essential print object”), which is typified by the facsimile receiving record and the inspection and maintenance record of the MFP 100 (see FIGS. 4A and 4B) explained in the above paragraphs of “SUMMARY OF THE INVENTION,” are stored in the RAM 202 or the HDD 204. Note that the facsimile receiving record and the inspection and maintenance record are examples of the essential print object. Further, it is possible to include other print objects regarding the MFP 100, if these other print objects are regarded as necessary by a user in the category of the essential print object.

The essential print object is allowed to be printed out in response to a user's instruction through the touch screen 302 when a user regards its printing as necessary. Also, it is possible to print out automatically the essential print object at a regular basis (e.g., when the amount of data recorded in each sort of records reaches ten) without the user's instruction. Furthermore, it is possible to use these methods in combination.

Here, a condition that the essential print object is printed out in response to the user's instruction will be explained first. When a user inputs an instruction of printing the essential print object through the touch screen 302, first, a searching unit (searching section) 301 searches whether a sheet of paper having the suitable size for the essential print object exists in the paper feeding cassettes 114 based on the vertical and horizontal lengths that are needed for printing the data of the essential print object.

In the present embodiment, as illustrated in FIGS. 1 and 3, the MFP 100 is provided with three paper feeding cassettes 114. For example, the three paper feeding cassettes 114 store a single or plurality of sheets of paper, respectively, and the sizes of the sheets of paper stored therein are respectively, for example, A4, B4, and A3. A detecting unit 311 (e.g., an optical sensor and a position sensor) is provided in the interior of the paper feeding cassettes 114, respectively. The searching unit 301 is configured to search whether the sheets of paper having these sizes respectively exist in the paper feeding cassettes 114 based on a signal transmitted by the detecting unit 311 provided in each of the paper feeding cassettes 114.

When the suitable paper size for the above described printing is the A4 size, a selecting unit (selecting section) 303 selects a sheet of paper having the size A4 from the paper feeding cassettes 114, and a printing unit 305 prints the essential print object on the selected sheet of paper.

However, when it is judged that a sheet of paper having the size A4 does not exist (i.e., the sheet of paper is run out) as the search result, the selecting unit 303 selects a sheet of paper having the size larger than a sheet of paper having the size A4 (which is hereinafter referred to as “secondary suitable-sized paper”). Then, the printing unit (printing section) 305 prints the essential print object on a sheet of secondary suitable-sized paper. Note that in this case, even if a sheet of paper having the size smaller than the size A4, the sheet of paper is not selected as a sheet of secondary suitable-sized paper. This is because an end portion of the essential print object may not be able to be printed on a sheet of paper having the small size.

In the example, the sheets of paper having the sizes B4 and A3 are options of a sheet of secondary suitable-sized paper. In response to this, the selecting unit 303 displays the content that the sheets of paper having two sizes exist on the touch screen 302. Then, for example, a user instructs the selecting unit 303 to select a sheet of paper having the size B4 by manipulating the touch screen 302. Accordingly, the selecting unit 303 selects a sheet of paper having the size B4 from the paper feeding cassettes 114, and the printing unit 305 prints the essential print object on the selected sheet of paper. Thus, even when a sheet of paper having the suitable size for the essential print object does not exist, the essential print object is absolutely printed on some form of paper.

Here, the selecting unit 303 informs a managing unit (managing section) 304 that a sheet of paper having the size B4 is selected as a sheet of secondary suitable-sized paper. Accordingly, as an operation of selecting a sheet of secondary suitable-sized paper is repeated, it is possible for the managing unit 304 to manage which size of paper is often selected, that is, frequency of selection for each of the paper sizes.

Next, based on the above, a condition that the essential print object is automatically printed out at a regular basis will be hereinafter explained.

As described above, for example, when the number of data recorded in the facsimile receiving record reaches ten (i.e, when ten fax transmissions are received), the searching unit 301 searches whether a sheet of paper having the suitable size for the essential print object exists in the paper feeding cassettes 114 in a way similar to the above. If the sheet of paper having the suitable size for the essential print object is the A4 size paper, the selecting unit 303 selects a sheet of paper having the size A4 from the paper feeding cassettes 114, and the printing unit 305 prints the essential print object on the selected sheet of paper.

On the other hand, if it is judged that a sheet of paper having the size A4 does not exist as the search result, the selecting unit 303 inquires the managing unit 304 about the size that has been most-frequently used as the size of the secondary suitable-sized paper in the past. Accordingly, the managing unit 304 informs the selecting unit 303 of the most-frequently used paper size based on the frequency for each of the paper sizes, which is managed by the managing unit 304 as described above.

If the size is the size B4, for instance, the selecting unit 303 selects a sheet of paper having the size B4 as a sheet of secondary suitable-sized paper. Then, the printing unit 305 prints the essential print object on the sheet of secondary suitable-sized paper. When the selecting unit 303 is configured (i.e., programmed) as described above, the MFP 100 learns a sheet of second suitable paper preferably used by a user and preferentially uses the sheet of secondary suitable-sized paper. Accordingly, it is possible to standardize the paper size, and an operation, such as filing of the sheet of paper on which the essential print object is printed, becomes convenient.

Furthermore, when an authenticating unit (authenticating section) 306 is provided, which is configured to perform a user authentication, it is also possible to perform the following operation. For example, as described above, when a user selects a sheet of secondary suitable-sized paper by inputting his/her instruction, he/she inputs the user ID and the password through the touch screen 302 and the authenticating unit 306 performs the user authentication.

Then, if the authentication is successfully completed for the user and the authenticated user instructs a sheet of secondary suitable-sized paper by selecting it through the touch screen 302 in the similar way to the above, the managing unit 304 is informed of the selected paper size and the user ID.

With the configuration, it is possible for the managing unit 304 to manage the frequency of selection of the sheet of secondary suitable-sized paper for each of the users. Also, even when the essential print object is automatically printed on a sheet of paper, it is possible to select a sheet of secondary suitable-sized paper that corresponds to the each user's preference. Therefore, an operation such as the above described filing becomes further convenient.

Furthermore, it is also possible to program the printing unit 305 so that the printing unit 305 expands the essential print object to the size suitable for a sheet of secondary suitable-sized paper. Accordingly, it is possible to produce a printed material on which the essential print object is printed, which is viewable for a user depending on the user's needs.

As described above, according to the present invention, it is possible to print out reliably and clearly the record (e.g., the facsimile receiving record) even when paper has run out.

According to the image forming device of the present invention, it is possible to enhance convenience of the office management and safety of the information management by reliably and clearly printing the essential print object such as the facsimile receiving record even when paper has run out. In addition, the image forming device learns a sheet of secondary suitable-sized paper preferred by a user, for instance, and preferentially uses the sheet of secondary suitable-sized paper. Therefore, an operation such as filing of the sheet of paper on which the essential print object is printed becomes convenient. Therefore, the image forming device of the present invention is useful as a printer, a photocopier, a facsimile machine, a MFP and the like.

### Second Embodiment

Here, a second preferred embodiment of the present invention will be explained by focusing on the difference between the first and second embodiments.

Here, for better understanding, when elements of the second embodiment are the same as the above explained elements of the first embodiment, they are given the same reference numerals that are given to the corresponding elements of the first embodiment.

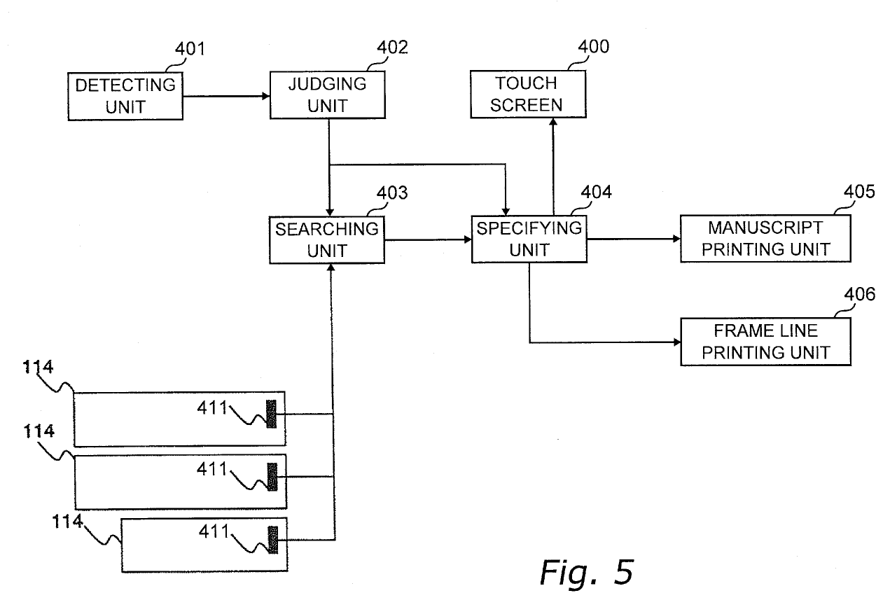

FIG. 5 is a view of a diagram illustrating a configuration of software in the MFP 100 of the second embodiment of the present invention. The configuration of the MFP 100 of the second embodiment is almost the same as that of the first embodiment except for the following points.

When a user attempts to print out a manuscript, a detecting unit (detecting section) 401 detects the long and short diameters of the manuscript based on the image data of the manuscript to be printed. Then, a judging unit (judging section) 402 judges whether the size of the manuscript is classified as the standard size based on the long and short diameters.

In the present embodiment, a condition is exemplified that the sheets of paper having three sizes (i.e., the sizes A4, B4, and A3) are stored as the standard size (i.e., size often used in a printing operation) in the paper feeding cassettes 114. Here, the size A4 has a length of 297 mm and a width of 210 mm. The size B4 has a length of 364 mm and a width of 257 mm. The size A3 has a length of 594 mm and a width of 420 mm.

The judging unit 402 judges whether the detected length and width of the manuscript correspond to any of the above described values. Then, for example, when the length and width correspond to those of the size A4, a searching unit (searching section) 403 searches whether a sheet of paper having the size A4 exists in the paper feeding cassettes 114.

A detecting unit 411 such as an optical sensor is provided in the interior of each of the paper feeding cassettes 114, respectively. The searching unit 403 is configured to search whether the sheet of paper having the corresponding size (i.e., the size A4) exists based on a signal transmitted by the detecting unit 411. Then, a manuscript printing unit 405 selects a sheet of paper having the size A4 from the paper feeding cassettes 114, and prints the above described manuscript on the sheet of paper having the size A4.

On the other hand, when the judging unit 402 judges that the size of the manuscript does not correspond to any of the above values (i.e., the size of the manuscript is classified as the non-standard size), the judging unit 402 informs a specifying unit (specifying section) 404 of the discrepancy.

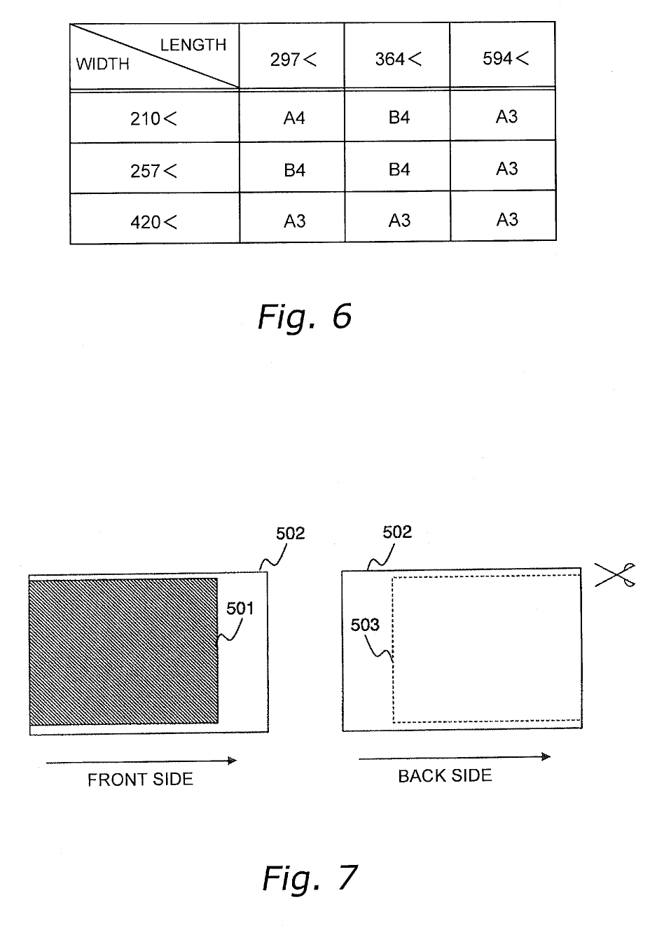

For example, as illustrated in FIG. 6, the specifying unit 404 includes a correspondence table of the length and width of a manuscript and the standard size. The specifying unit 404 specifies a sheet of paper having the standard size larger than the size of the manuscript when the size of the manuscript is judged to be non-standard. In the example, the size of the manuscript is specified as the size A4 if its length is less than 297 mm and its width is less than 210 mm. On the other hand, the size of the manuscript is specified as the size B4 if its length is greater than or equal to 297 mm and less then 364 mm, or its width is greater than or equal to 210 mm and less than 257 mm. In way similar to the above, the manuscript is specified as the size A3 if its length is greater than or equal to 364 mm and less than 594 mm, or its width is greater than or equal to 257 mm and less than 420 mm. In other words, the specifying unit 404 specifies paper having the smallest standard size larger than the manuscript having the non-standard size.

The specifying unit 404 relates the manuscript having the non-standard size to a sheet of paper having the standard size (e.g., B4) based on the correspondence table. Accordingly, the searching unit 403 searches whether a sheet of paper having the size B4 exists in the paper feeding cassettes 114, and the manuscript printing unit 405 selects a sheet of paper having the size B4 from the paper feeding cassettes 114, and prints the manuscript on the sheet of paper having the size B4.

As described above, when a manuscript having the non-standard size is printed out in the MFP 100 of the present invention, it is not necessary to perform a series of processing of printing explained in the above paragraphs of “Background Art” in which a user inputs the non-standard size into the image forming device through the touch screen and the like and then supplies a sheet of paper having the non-standard size from a manual feeding tray provided in the image forming device. Therefore, even a general user without control authority of changing the configuration (e.g., input of the non-standard size) is allowed to obtain simply and rapidly a printed material.

Note that in this case, the specifying unit 404 may be configured (i.e., programmed) to cause the touch screen 400 to display a message such as “non-standard size→manuscript will be printed on B4 Paper.” With the configuration, a user is capable of recognizing that the size of the manuscript is classified as the non-standard size. In addition, even when a sheet of paper having the size B4 is run out, the user is capable of recognizing that he/she needs to supply a sheet of paper having the size B4.

Furthermore, according to the present invention, a frame line printing unit (frame line printing section) 406 is provided. When a manuscript 501 having the non-standard size is printed on a sheet of paper 502 having the standard size as illustrated in FIG. 7, the frame line printing means 406 prints a frame line 503 having the non-standard size on a part of the back side of the sheet of paper having the standard size, which corresponds to the part of the front side of the paper on which the manuscript is printed. Accordingly, a user is capable of obtaining a printed material having the non-standard size by cutting the sheet of paper along the frame line as necessary.

According to the image forming device of the present invention, even a general user without control authority for the configuration change is allowed to obtain simply and rapidly a printed material having the non-standard size. Therefore, the image forming device of the present invention is useful for a printer, a photocopier, a MFP and the like.

### General Interpretation

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers, and/or steps. The foregoing also applied to words having similar meanings such as the terms, “including,” “having,” and their derivatives. Also, the term “part,” “section,” “portion,” “member,” or “element” when used in the singular can have the dual meaning of a single part or a plurality of parts. Finally, terms of degree such as “substantially,” “about,” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

What is claimed is:

1. An image forming device, comprising:
a plurality of paper feeding cassettes, the paper feeding cassettes being configured to store respectively a single or plurality of sheets of paper, the sheets of paper having a plurality of paper sizes;
a searching section being configured to search whether a sheet of paper having a suitable size for an essential print object exists or not when the essential print object is printed out, the essential print object being a print object that is absolutely required to be printed;
a selecting section being configured to select a sheet of secondary suitable-sized paper from the sheets of paper having a plurality of paper sizes when the sheet of paper having the suitable size for the essential print object does not exist, the sheet of secondary suitable-sized paper being defined to be larger than the sheet of paper having the suitable size for the essential print object; and
a printing section being configured to print the essential print object on the sheet of secondary suitable-sized paper.

2. The image forming device of claim 1, wherein the selecting section is configured to perform the selection based on a user's instruction.

3. The image forming device of claim 2,
further comprising a managing section, the managing section manages the frequency of the selection for each of the plurality of paper sizes, and
wherein the selecting section automatically selects the sheet of secondary suitable-sized paper based on the frequency.

4. The image forming device of claim 3,
further comprising an authenticating section, the authenticating section performs a user authentication, and
wherein the managing section manages the frequency for each of the users.

5. The image forming device of claim 1, wherein the print section is configured to expand the essential print object to the suitable size for the sheet of secondary suitable-sized paper and prints the expanded essential print object on the sheet of secondary suitable-sized paper.

6. An image forming device, comprising:
a plurality of paper feeding cassettes, the paper feeding cassettes being configured to store a single or plurality of sheets of paper, the sheets of paper having a plurality of paper sizes;
a detecting section, the detecting section being configured to detect the size of a manuscript;
a searching section, the searching section being configured to search whether a sheet of paper having suitable size for the manuscript exists or not;
a judging section being configured to judge whether the size of the manuscript is classified as either a standard size or a non-standard size;
a specifying section being configured to specify a sheet of paper having the standard size larger than the size of the manuscript when the size of the manuscript is judged to be classified as the non-standard size;
a manuscript printing section being configured to print the manuscript on the specified sheet of paper having the standard size; and
a frame line printing section being configured to print a frame line having the non-standard size on the back side of the sheet of paper having the standard size so that the position of the frame boarder line corresponds to the position of the manuscript on the front side of the sheet of paper having the standard size.

7. The image forming device of claim 6, wherein the specifying section specifies a sheet of paper having the smallest standard size larger than the manuscript having the non-standard size.
